(19) United States
(12) Patent Application Publication
(10) Pub. No.: US 2023/0051653 A1
(43) Pub. Date: Feb. 16, 2023

(54) ACCESSORY FOR MAKING AND COUPLING A FLOW PATH BETWEEN A PACKAGE AND A TESTER

(71) Applicants: Bruno Pierre Henri BINET, Singapore (SG); Jean Philippe GUILLOT, Pathum Thanee (TH)

(72) Inventors: Bruno Pierre Henri BINET, Singapore (SG); Jean Philippe GUILLOT, Pathum Thanee (TH)

(21) Appl. No.: 17/797,209

(22) PCT Filed: Feb. 5, 2020
(86) PCT No.: PCT/TH2020/000008

§ 371 Date: Aug. 3, 2022

(51) Int. Cl. G01M 3/02

(52) U.S. Cl. CPC G01M 3/027

(57) ABSTRACT

The present invention discloses an accessory for making and coupling a flow path between a package and a tester. The accessory is configured to automatically make a hole onto a package. The accessory is further configured to form a hole without utilizing a hollow needle or a septum. The accessory is further configured to couple the hole of the package to the tester, which could be a leakage tester or a gas tester, or a tester that performs both gas detection test and leakage test. The accessory is further configured to seal a flow path between the hole and the tester from an external environment. The accessory is further configured to make and couple the flow path between the package and the tester either manually or automatically.

### BACKGROUND OF THE INVENTION

### A. Technical Field

The present invention generally relates to an accessory for making and coupling a flow path between a package and a leakage tester or a gas tester, or a tester that performs both leakage test and gas detection test.

### B. Description of Related Art

Packaging material such as polymer or polymer derivatives has been widely used for packaging in many industries. These materials are manufactured in any size and shape and accordingly are advantageous to package manufacturing. Each package contains a commodity/content that has to be protected by excluding or sealing out the ambient environment about the package, or by maintaining the contents in a desired ambient within the package. The shelf-life of the commodity primarily depends on the integrity of the sealed package.

The final sealing step during the packaging process is achieved by fusing similar materials, which are used on both the lid and container. This creates a very safe seal which is nearly impossible to break. However, this creates problems for the consumer since there is great difficulty in opening such packages. In order to avoid marketing problems, seals have been made, which are easier to open but have a greater chance of being unsealed. Problems in the defective seals may be due to wrinkles in the packaging, improper temperatures, contamination of the seal with extraneous material, absence of adhesive and variability of the sealant thickness. Further, packaging made of light and flexible material are less resistant to puncturing, slicing and other problems than conventional metallic or glass material.

Conventionally, a number of detecting devices have been made to check the integrity of the package and reject the improperly sealed packages. One method involves pressurizing the package with gas other than air and then examined for escaping gas with a gas leak detector.

Another method involves creating a closed space around the test package, creating a surrogate chamber, and pressurizing (or evacuating) the closed space. Air entering the package through a leak (or in the case of a vacuum test, leaving the package through the leak) provides the measurement of leakage. Yet another method involves utilizing a hollow needle to pierce the package through a septum and checked for leakage of gas or air.

Yet another method involves inserting a hypodermic needle into the package and inflating it with air. The needle is then withdrawn and the tester places his finger over the needle hole and places the package into a container filled with fluid and escaping bubbles are observed.

Although many package testing procedures exist, many of these tests involve destructive methods that are not adaptable to in-line testing. Therefore, test packaging or off-line samples are utilized for the testing, making it difficult to ensure the in-line packages are reliable and/or requiring a reduced yield in order to provide sufficient samples for off-line testing. In addition, the current non-destructive tests are time consuming, also resulting in reduced yield or fewer packages being tested on-line.

Therefore, there is a need for an improved accessory for use with a leakage tester, a gas tester or a tester that performs both leakage test and gas detection test that overcomes the one or more above discussed drawbacks.

### SUMMARY OF THE INVENTION

The present invention discloses an accessory for making and coupling a flow path between a package and a leakage tester or a gas tester, or a tester that performs both leakage test and gas detection test.

According to the present invention, the accessory comprises a hollow member, a conduit member, a piercing member, a driving member, a bellow member and a dome member. The conduit member is in fluid communication with the hollow member. The piercing member is disposed within the hollow member. The piercing member is configured to move vertically between a retracted position and an operative position. The driving member is coupled to the piercing member. The driving member is configured to move the piercing member between the retracted position and the operative position. The bellow member is disposed at a distal end of the hollow member. The dome member extends from a distal portion of the hollow member and surrounds at least a portion of length of the bellow member.

The accessory further comprises a laser assembly to identify a suitable piercing area on the package to make or form the hole. The laser assembly includes a pair of laser beam emitter. Each emitter is disposed at opposing sides of the dome member configured to emit laser beam. Further, a holder member is provided to move the accessory. The accessory further comprises one or more internal laser sensors to measure the height of the package to provide information for calculating the piercing depth.

The user places the package above a flat area of a package holder. The location for placement of the package is identified by emitting the laser beam. The user brings the accessory close to the package using the holder member until the dome member touches the package and the bellow member is retracted. The bellow member forms a tight seal around the piercing area. A differential pressure sensor in communication with a microcontroller measures the rise in pressure due to the retraction of the bellow member and signals the microprocessor. The microprocessor is configured to activate the drive member to move the piercing member between the rest position and the operating position.

The piercing member makes the tiny hole and retracts to the retracted position. The bellow member surrounding the hole creates an isolated area between the hole of the package and the flow path connecting the conduit member and tester. The accessory is configured to send a wireless signal to the tester to perform the test. In one embodiment, the tester is the gas tester. In another embodiment, the tester is the leakage tester. In yet another embodiment, the tester could perform both leakage test and gas detection test/gas test.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 exemplarily illustrates an accessory for making and coupling a flow path of a package with a tester, according to an embodiment of the present invention.

FIG. 2 exemplarily illustrates a perspective view of the accessory without housing, according to an embodiment of the present invention.

FIG. 3 exemplarily illustrates a cross sectional view of the accessory, according to an embodiment of the present invention.

FIG. 4 exemplarily illustrates a bottom view of the accessory, according to an embodiment of the present invention.

FIG. 5 exemplarily illustrates a cross sectional view of the accessory, according to another embodiment of the present invention.

FIG. 6 exemplarily illustrates a see-through view of the accessory, according to an embodiment of the present invention.

FIG. 7 exemplarily illustrates a see-through view illustrating the operation of the accessory, according to an embodiment of the present invention.

FIG. 8 exemplarily illustrates a holder member of the accessory, according to an embodiment of the present invention.

FIG. 9 exemplarily illustrates the accessory being automated in in-line facility, according to an embodiment of the present invention.

### DETAILED DESCRIPTION OF EMBODIMENTS

A description of embodiments of the present invention will now be given with reference to the figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

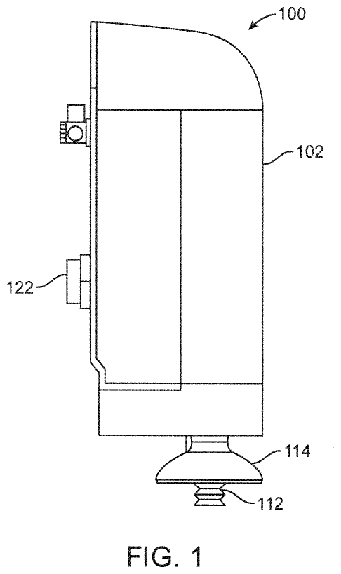

Referring to FIG. 1, the present invention discloses an accessory 100 for making and coupling a flow path of a package with a tester, according to an embodiment of the present invention. The accessory 100 is configured to automatically make a hole onto a package. The accessory 100 is configured to fork a hole without utilizing a hollow needle or a septum. The accessory 100 is configured to couple the hole of the package to the tester, which could be a leakage tester or a gas tester or tester that could perform both leakage test and gas detection test (hereinafter referred as “combined tester”). The accessory 100 is configured to seal a flow path between the hole and the tester from an external environment. Referring to FIG. 1 to FIG. 9, the accessory 100 comprises a housing 102 enclosing a hollow member 104, a conduit member 106, a piercing member 108, a driving member 110, a bellow member 112, and a dome member 114.

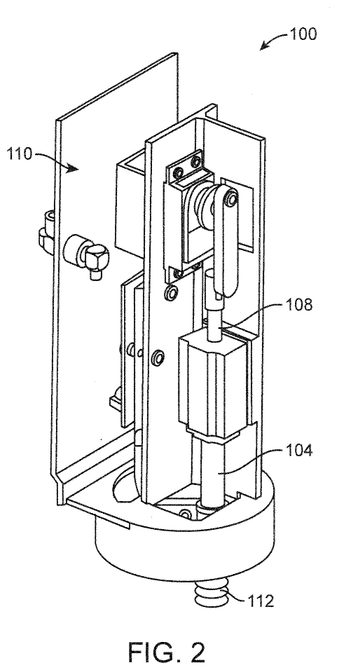

Referring to FIG. 2, the piercing member 108 is disposed within the hollow member 104. The driving member 110 is coupled to the piercing member 108. The piercing member 108 is configured to move vertically between a retracted position and an operative position. The driving member 110 is configured to move the piercing member 108 between the retracted position and the operative position. The driving member 110 utilizes a motor to move the piercing member 108 between the retracted position and the operative position. In another embodiment, the driving member 110 comprises at least any number of conventional structures, including, but not limited to hydraulic cylinders, mechanical drives, electric actuators, hydraulic actuators, chain or belt drives, rack and pinion drives, to drive the piercing member 108. In one embodiment, the piercing member 108 is a pointed rod.

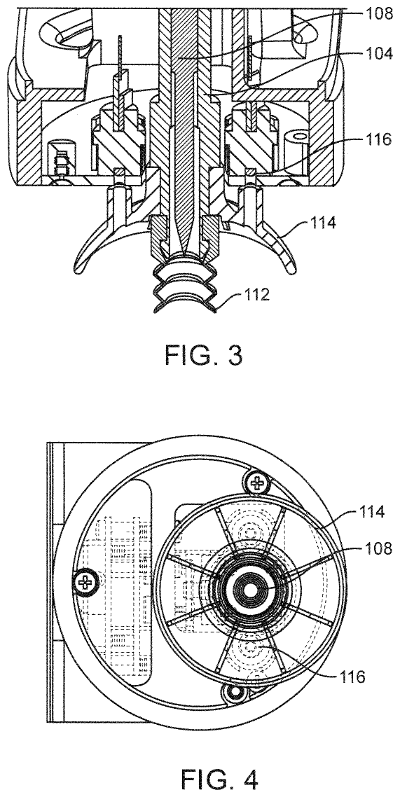

Referring to FIG. 3, the bellow member 112 is disposed at a distal end of the hollow member 104. The bellow member 112 is provided to surround the end of the piercing member 108. The bellow member 112 is a retractable bellow member. The dome member 114 extends from a distal portion of the hollow member 104 and surrounds at least a portion of length of the bellow member 112. Referring to FIG. 4, the accessory 100 further comprises a laser assembly to identify a suitable piercing area on the package to make or form the hole. The laser assembly includes a pair of laser beam emitter 116. Each emitter 116 is disposed at the opposing side of the dome member 114 configured to emit laser beam.

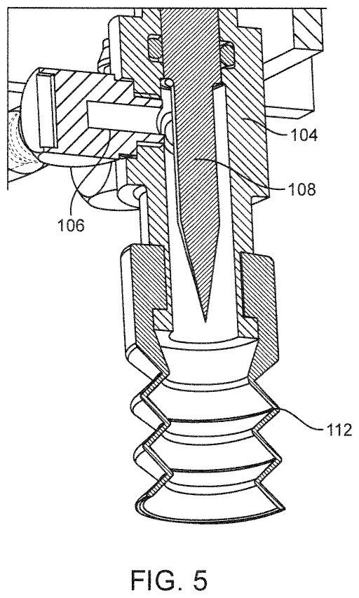

In one embodiment, the dome member 114 is an inverted cup configured to stretch the packaging film on contacting the package. Referring to FIG. 5, the conduit member 106 is in fluid communication with the hollow member 104. The conduit member 106 could be coupled or operatively connected to at least one of the gas tester, the leakage tester or the combined tester to perform the gas detection test, the leakage test, or the gas detection test and leakage test, respectively. The conduit member 106 could be coupled to the gas tester or the leakage tester or the combined tester via a fitting member 122.

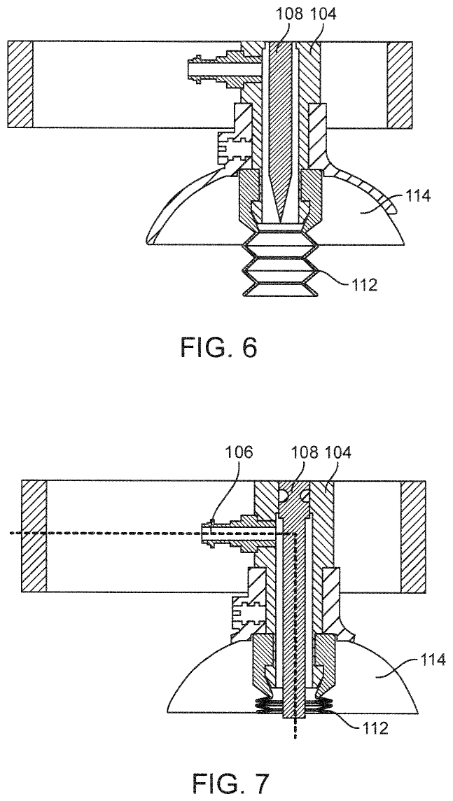

FIG. 6 illustrates a see-through view of the accessory 100 at a rest position, according to an embodiment of the present invention. A flow path connecting the conduit member 106, the hollow member 104 and the bellow member 112 is illustrated.

FIG. 7 exemplarily illustrates a see-through view illustrating the operation of the accessory 100, according to an embodiment of the present invention. The user places the package on a flat area of a package holder. The location for placement of the package is identified by emitting the laser beam. The accessory 100 further comprises one or more internal laser sensors to measure the height of the package to provide information for calculating the piercing depth. The laser sensors are configured to provide more accurate and dynamic data for calculating the piercing depth. At least one laser sensor is configured to measure the distance to the package holder and at least one laser sensor is configured to measure the distance to a top surface of the package. The difference in the distance provides information of the height of the package. ¾ of the height is used as the piercing depth.

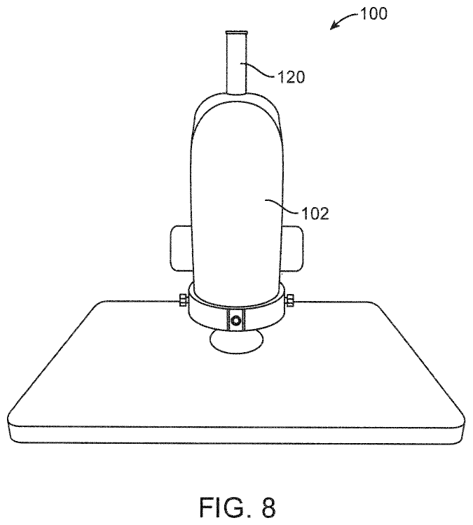

Referring to FIG. 8, the user brings the accessory 100 close to the package using a holder member 120 until the dome member 114 touches the package. Simultaneously, the bellow member 112 also contacts the piercing area and forms the tight seal around the piercing area. On retraction of the bellow member 112, pressure in the bellow member 112 increases, which is measured by a differential pressure sensor and transmitted to a microprocessor. The microprocessor is configured to activate the drive member to move the piercing member 108 between the rest position and the operating position. The microprocessor is in communication with the drive member, the laser assembly, the differential pressure sensor and the internal laser sensors. In one embodiment, the accessory 100 comprises a battery pack for receiving power. In another embodiment, the accessory 100 could be connected to the main adaptor.

On activation of the drive member, the piercing member 108 makes the tiny hole and retracts the piercing member 108 to the retracted position. The bellow member 112 surrounding the hole creates an isolated area between the package and the flow path connecting the conduit member 106 and tester. The accessory 100 is configured to send a wireless signal to a receiver in communication with tester to perform the test. The receiver is configured to convert the signal into a form readable by the tester, i.e., a relay that is wired to the tester input, to start and perform the test. In one embodiment, the tester is the gas tester. In another embodiment, the tester is the leakage tester. In yet another embodiment, the tester is the combined tester.

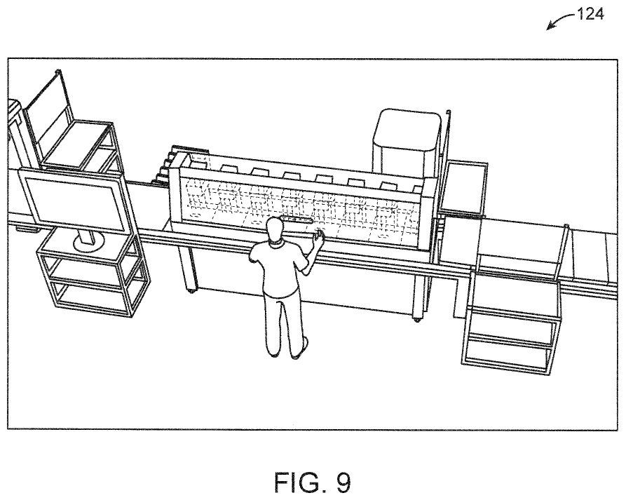

On completion of the test, the user rises the accessory 100 using the holder member 120 and removes the package. Referring to FIG. 9, an environment 124, where the operation for making and coupling the flow path of the package with the tester is automated, according to one embodiment of the present invention. The package is automatically positioned below the bellow member for use in in-line facility or on-line facility. The bellow member 112 contacts the piercing area and forms the tight seal around the piercing area. On retraction of the bellow member 112, pressure in the bellow member 112 increases, which is measured by a differential pressure sensor and transmitted to a microprocessor. The microprocessor is configured to activate the drive member to move the piercing member 108 between the rest position and the operating position.

On activation of the drive member, the piercing member 108 makes the tiny hole and retracts the piercing member 108 to the retracted position. The bellow member 112 surrounding the hole creates an isolated area between the package and the flow path connecting the conduit member 106 and tester. The accessory 100 is configured to send a wireless signal to the tester to perform the test. In one embodiment, the tester is the gas tester. In another embodiment, the tester is the leakage tester. In yet another embodiment, the tester is the combined tester. On completion of the test, the package is removed.

In one embodiment, the accessory 100, optionally, comprises the laser sensors. The accessory 100 could be incorporated with a software module, which contains instructions to pierce the package at a fixed value. In one embodiment, the driving member 110 could utilize the data from at least one of software module or laser sensors for actuating the piercing member 108.

Advantageously, the present invention provides the accessory 100 to pierce and to isolate the punched hole in a packaging's film for the purpose of connecting the inside of the packaging to a gas or leak tester for the purpose of measuring the leakage or the gas concentration present in the packaging without a needle nor a septum. The accessory 100 could be connected to any type of gas tester or leak tester, or combined tester.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, various alternatives, modifications, and equivalents may be used. Therefore, the above description and the examples should not be taken as limiting the scope of the invention, which is defined by the appended claims.

1. An accessory for a leakage or gas tester, comprising:
a hollow member;
a conduit member in fluid communication with the hollow member;
a piercing member disposed within the hollow member, wherein the piercing member is configured to move vertically between a retracted position and an operative position;
a driving member coupled to the piercing member, wherein the driving member is configured to move the piercing member between the retracted position and the operative position;
a bellow member disposed at a distal end of the hollow member, and
a dome member extends from a distal portion of the hollow member and surrounds at least a portion of length of the bellow member,
wherein the bellow member is brought into contact with a piercing area of a package to form a seal around the piercing area,
wherein the piercing member passes through the bellow member to pierce the piercing area and returns to the retracted position to form a hole on the package,
wherein the bellow member is configured to create a sealed flow path connecting the hole of the package, the bellow member, the hollow member and the conduit member, and
wherein the conduit member is coupled to at least one of the gas tester, the leakage tester, or a combined tester to perform a gas test, a leakage test, or the gas test and leakage test, respectively.

2. The accessory of claim 1, further comprises a holder member to move the accessory at a desired position.

3. The accessory of claim 1, wherein the bellow member is a retractable bellow member.

4. The accessory of claim 1, wherein the bellow member moves to a retracted position on contacting the package.

5. The accessory of claim 4, wherein the retracted position of the bellow member rises a pressure within the bellow member.

6. The accessory of claim 1, further comprises a differential pressure transducer in fluid communication with the bellow member, wherein the differential pressure transducer is configured to detect in the rise of pressure.

7. The accessory of claim 1, further comprises a microprocessor in communication with the differential pressure sensor configured to receive a signal indicating the rise of pressure, and activate the driving member to move the piercing member to the operative position.

8. The accessory of claim 1, further comprises one or more internal laser sensors in communication with the microprocessor to measure a height of the package to provide information for calculating a piercing depth.

9. The accessory of claim 1, further comprises a pair of laser beam emitter disposed at opposing sides of the dome member to emit laser beam and locate the piercing area of the package.

10. The accessory of claim 1, wherein the package is automatically positioned below the bellow member for use in in-line facility.

11. The accessory of claim 1, wherein the package is automatically positioned below the bellow member by a user.
